(19) United States
(12) Patent Application Publication
(10) Pub. No.: US 2025/0128954 A1
(43) Pub. Date: Apr. 24, 2025

(54) OVER-STOICHIOMETRIC LITHIUM-BASED TRANSITION METAL-BASED CATION DISORDERED ROCK SALTS AS HIGH-ENERGY DENSITY LITHIUM-ION BATTERY MATERIALS

(71) Applicant: UNM RAINFOREST INNOVATIONS, Albuquerque, NM (US)

(72) Inventors: Dongchang CHEN, Albuquerque, NM (US); Alexandra OUTKA, Albuquerque, NM (US); Basirat RAJI-ADEFILA, Albuquerque, NM (US); You WANG, Albuquerque, NM (US)

(21) Appl. No.: 18/919,940

(22) Filed: Oct. 18, 2024

Related U.S. Application Data
(60) Provisional application No. 63/591,533, filed on Oct. 19, 2023.

(51) Int. Cl. C01D 15/02; H01M 10/0525

(52) U.S. Cl. CPC C01D 15/02; H01M 10/0525; C01P 2002/72; C01P 2002/82; C01P 2006/40

(57) ABSTRACT

An over-stoichiometric lithium-based transition metal-based cation-disordered rock salt cathode for a lithium-ion battery in a metastable state that includes an over-stoichiometric amount of lithium and at least one transition metal, in which the cathode has a mole ratio of total cations to total anions being greater than 1:1, and methods to synthesize the over-stoichiometric lithium-based transition metal-based cation-disordered rock salt cathode.

### CROSS-REFERENCE TO RELATED APPLICATIONS

This application claims priority to provisional U.S. Patent Application Ser. No. 63/591,533 filed on Oct. 19, 2023, the disclosure of which is herein incorporated by reference in its entirety.

### TECHNICAL FIELD

The subject matter described herein relates generally to lithium-ion battery materials and, more particularly, to over-stoichiometric lithium-based transition metal-based cation disordered rock salts as high-energy density lithium-ion battery material.

### BACKGROUND

Cation-disordered rock salts have been well known for their potential to realize the goal of achieving scalable nickel and cobalt free high-energy density lithium-ion batteries. Unlike in most cathode materials, the disordered cation distribution may lead to more factors that control the electrochemistry of cation-disordered rock salts. An important variable that has not been emphasized by the research community is regarding whether a cation-disordered rock salt exists in a more thermodynamically stable form or a more metastable form. Moreover, within the scope of metastable cation-disordered rock salts, over-stoichiometric cation-disordered rock salts, which allow relaxation of the site balance constraint of a rock salt structure, are particularly under explored.

### SUMMARY OF THE INVENTION

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

There is a need for improving the structural and compositional space of cation-disordered rock salt families, and the improvements provide new pathways for rationally tuning the properties of cation-disordered rock salt cathodes. A generally applicable approach to “metastabilize” the thermodynamically stable transition metal-based cation-disordered rock salts is by introducing lithium over-stoichiometry. The over-stoichiometric metastabilization greatly stimulates more redox activities, enables better reversibility of lithium deintercalation/intercalation, and changes the energy storage mechanism. The metastabilized cation-disordered rock salts can be transformed back to the thermodynamically stable form, which also revert the electrochemical properties, further contrasting the two categories of cation-disordered rock salts.

Over-stoichiometric lithium-based cation-disordered rock salts herein are shown to have improved performance over a stoichiometric lithium-based cation-disordered rock salt, such as having a higher electrochemical capacity which is desirable for lithium-ion battery improvements.

In an exemplary embodiment, there is an over-stoichiometric cation-disordered rock salt cathode that comprises a cation-disordered rock salt having an over-stoichiometric amount of lithium, and at least one transition metal.

In another embodiment, there is a lithium-ion battery having an over-stoichiometric lithium, that comprises a cathode having a cation-disordered rock salt that includes an over-stoichiometric amount of lithium and at least one transition metal; and an anode.

In a further embodiment, there is a method to synthesize an over-stoichiometric cation-disordered rock salt cathode for a lithium-ion battery that comprises providing at least one lithium-based and transition metal-based compound; mixing the lithium-based and transition metal-based compound with a lithium-based additive; and producing an over-stoichiometric lithium-based cation-disordered rock salt cathode.

### BRIEF DESCRIPTION OF DRAWINGS

The accompanying drawings, which are incorporated in and constitute a part of this specification, illustrate embodiments of the present teachings and together with the description, serve to explain the principles of the disclosure. In the figures:

FIG. 1A is a flow chart of a first exemplary method of synthesizing an over-stoichiometric lithium-based transition metal-based cation-disordered rock salt cathode;

FIG. 1B is a flow chart of a second exemplary method of synthesizing an over-stoichiometric lithium-based transition metal-based cation-disordered rock salt cathode;

FIG. 2A is a graph of X-ray diffraction patterns of a stoichiometric Li—Ti—Mn—O—F based rock salt (hereinafter as “LTMOF”), and the over-stoichiometric 10% extra mole ratio lithium Li—Ti—Mn—O—F based rock salt (hereinafter as “MS10-LTMOF”) and 20% extra mole ratio lithium Li—Ti—Mn—O—F based rock salt (hereinafter as “MS20-LTMOF”) cation-disordered rock salt cathodes;

FIG. 2B is a graph of Raman spectra of the stoichiometric LTMOF and the over-stoichiometric MS10-LTMOF and MS20-LTMOF cation-disordered rock salt cathodes;

FIG. 3 is a graph of the electrochemical performance of LTMOF, MS10-LTMOF, and MS20-LTMOF in the first cycle;

FIG. 4 is a graph of measured accessible lithium-ion amount of LTMOF compared to MS10-LTMOF and MS20-LTMOF, under a current density of 10 mA g⁻¹;

FIGS. 5A, 5B, and 5C are graphs of the electrochemical performance of LTMOF, MS10-LTMOF, and MS20-LTMOF in the first 20 cycles under the current density of 10 mA g⁻¹;

FIGS. 6A, 6B, and 6C are graphs of the electrochemical performance of LTMOF, MS10-LTMOF, and MS20-LTMOF in the first 20 cycles under the current density of 20 mA g⁻¹;

FIGS. 7A, 7B, and 7C are graphs of the electrochemical performance of LTMOF, MS10-LTMOF, and MS20-LTMOF every five cycles in the first 40 cycles under the current density of 50 mA g⁻¹;

FIGS. 8A, 8B, and 8C are graphs of the electrochemical performance of LTMOF, MS10-LTMOF, and MS20-LTMOF every five cycles in the first 40 cycles under the current density of 500 mA g⁻¹;

FIGS. 9A, 9B, and 9C are graphs of the discharge specific capacity retention of LTMOF, MS10-LTMOF, and MS20-LTMOF under the current density of 10, 50, and 500 mA g⁻¹;

FIGS. 10A, 10B, and 10C are graphs of the discharge voltage retention of LTMOF, MS10-LTMOF, and MS20-LTMOF under the current density of 10, 50, and 500 mA g⁻¹;

FIGS. 11A, 11B, and 11C are graphs of the rate of performance of LTMOF, MS10-LTMOF, and MS20-LTMOF under different current densities;

FIGS. 12A, 12B, 12C, 12D, and 12E are graphs that show the X-ray diffraction patterns, Raman spectra, electrochemical performance in the first cycle, and during the first 20 cycles of an over-stoichiometric 10% extra mole ratio lithium Li—Ti—Mn—O based rock salt (hereinafter as “MS10-LTMO”) compared to a stoichiometric Li—Ti—Mn—O based rock salt (hereinafter as “LTMO”);

FIGS. 13A, 13B, 13C, 13D, and 13E are graphs that show the X-ray diffraction patterns, Raman spectra, electrochemical performance in the first cycle, and during the first 20 cycles of an over stoichiometric 10% extra mole ratio lithium Li—Nb—Mn—O based rock salt (hereinafter as “MS10-LNMO”) compared to a stoichiometric Li—Nb—Mn—O based rock salt (hereinafter as “LNMO”); and

FIGS. 14A, 14B, 14C, 14D, and 14E are graphs that show the X-ray diffraction patterns, Raman spectra, electrochemical performance in the first cycle, and during the first 20 cycles an over stoichiometric 10% extra mole ratio lithium Li—Fe—O based rock salt (hereinafter as “MS10-LFO”) compared to a stoichiometric Li—Fe—O based rock salt (hereinafter as “LFO”).

It should be noted that some details of the FIGS. have been simplified and are drawn to facilitate understanding of the present teachings rather than to maintain strict structural accuracy, detail, and scale.

### DETAILED DESCRIPTION

Reference will now be made in detail to the present examples, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary implementations in which the present disclosure can be practiced. These implementations are described in sufficient detail to enable those skilled in the art to practice the present disclosure and it is to be understood that other implementations can be utilized and that changes can be made without departing from the scope of the present disclosure. The following description is, therefore, merely exemplary.

Among all electrochemical energy storage and conversion technologies, lithium-ion batteries are the most well-known option for realizing the goal of electrification of transportation and a net-zero emission economy, owing to the high energy density and well-developed industrial chain of lithium-ion battery productions. The major challenge for realizing this goal is on the cathode side of state-of-the-art lithium-ion batteries. Comparing to the inexpensive graphite and silicon anodes, conventional nickel and cobalt based cathodes have been well known for their drawbacks, including limited specific capacity, low earth abundance, difficulties of cobalt-mining, and toxicity of nickel and cobalt oxide compounds. Cation-disordered rock salt oxides, a series of new lithium-ion battery cathode materials where lithium and transition metals are fully mixed and dispersed in a face-centered-cubic anionic sublattice, are ideally suited for resolving the challenge of lithium-ion battery cathodes. As an example, manganese-based cation-disordered rock salts have been under the spotlight of cathode research community in recent years, owing to their superior electrochemical performance and earth abundance of manganese.

Compared to classic lithium cathode materials, one unique property of cation-disordered rock salts is that they can exist in either a thermodynamically stable form or a metastable form. Herein, “metastable” means that the material is stable at room or near-room temperatures but will convert to a different phase at higher temperatures (e.g. during an annealing process). For example, a diamond is at a metastable state, and graphite is at a thermodynamically stable state. Thermodynamically stable cation-disordered rock salts are typically synthesized via a high temperature solid-state synthesis approach, which assembles the elements from various precursors to a single phase with randomly distributed cations. Metastable cation-disordered rock salts are typically synthesized via various low-temperature methods, such as via a mechanochemistry method. The mechanical force decomposes the precursors, randomly disperses the elements, and generates a new metastable phase. In the scope of metastable cation-disordered rock salts, one of the most exciting opportunities is the over-stoichiometric chemical space. Herein, over-stoichiometry refers to the mole ratio between total cations to total anions being greater than 1:1, which allows the relaxation of the site balance constraint of the rock salt structure. While cation-disordered rock salts have been a research topic with fast growing interests in recent years, over-stoichiometric chemical space of cation-disordered rock salts is a highly under-explored field.

The over-stoichiometric lithium-based transition metal-based cation-disordered rock salt herein has improved properties, such as having a higher capacity that provides an increase in electrical charge, which was not observed previously by conventional methods of adding lithium ions into a lithium-ion battery material that included stoichiometrically balanced lithium and transition metals. It was observed that even a minor amount of over-stoichiometric lithium incorporated into a cation-disordered rock salt having stimulates more redox activity and enables better reversibility of lithium deintercalation and intercalation, which increases electrochemical charge, thus increases the capacity of a lithium-ion battery using an over-stoichiometric lithium compound.

An embodiment of a over-stoichiometric lithium-based cation-disordered rock salt as a cathode of a lithium-ion battery has a chemical formula of:

Liₐ₊ₓM_{b}O_{2-y}F_{y} Formula 1:

In Formula 1, “a” is a number no less than about 1. “a” can also be between about 1 and about 1.4, or no more than 1.4. “b” is a number no less than about 0.4, or between about 0.4 and about 1, or between about 0.7 and about 1. “y” is a number greater or equal to 0, or between about 0 and about 1, or no more than 0.7. “x” is a degree of over-stoichiometry, and “x” is a number greater or equal to 0, or between about 0 and about 1.0*(a+b), or between about 0 and about 0.4*(a+b), or between about 0 and about 0.2*(a+b).

Furthermore, “M” is a transition metal, including titanium (Ti), vanadium (V), chromium (Cr), manganese (Mn), iron (Fe), cobalt (Co), nickel (Ni), zirconium (Zr), niobium (Nb), molybdenum (Mo), ruthenium (Ru), tantalum (Ta), and tungsten (W), or a combination thereof.

Additionally, the formula includes an over-stoichiometric lithium ion, such that the sum of “a+x” and “b” equals more than 2. Alternatively, the mole ratio of lithium in the lithium-based additive and total metal elements in the preliminary product is a number represented by x/(a+b). For example, when using an elemental analysis to measure the molar ratio of Li, M (metal), O, and F, the mole ratio of total cations to total anions is greater than 1:1.

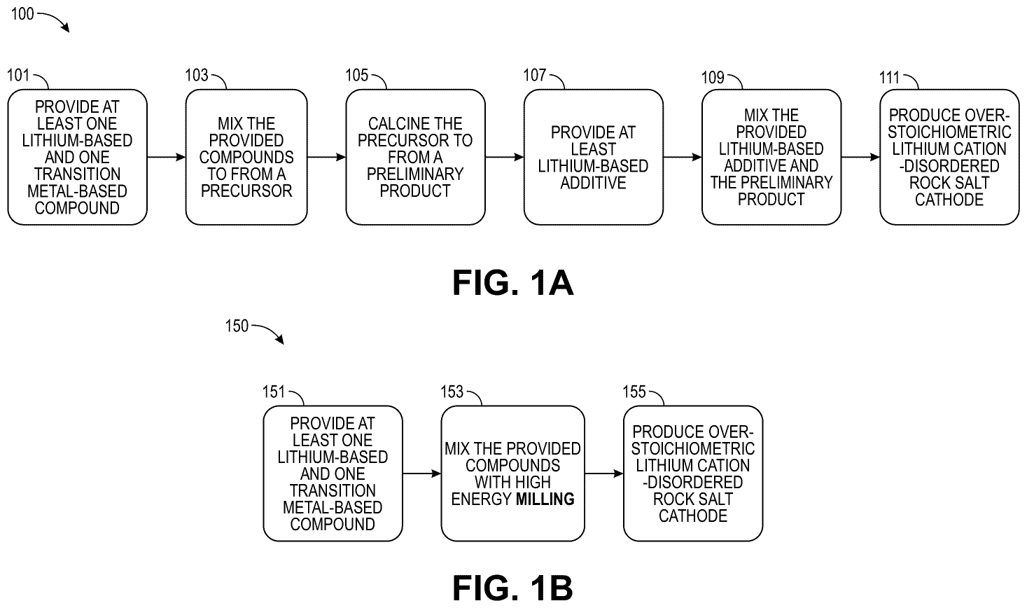

A first exemplary method 100 to synthesize an over-stoichiometric lithium cation-disordered rock salt cathode is shown in FIG. 1. At least one lithium-based and transition metal based compound is provided in step 101. Example lithium-based compounds include lithium carbonate (Li₂CO₃), lithium bicarbonate (LiHCO₃), lithium hydroxide (LiOH). Example transition metal compounds are transition metal oxides, transition metal hydroxides, and transition metal carbonates. The molar ratio of lithium in the lithium compound and transition metal in the transition metal compound is, for example, a number represented by (1.0)*a/b or (1.1)*a/b.

The at least one lithium-based and transition metal-based compound is mixed to form a precursor in step 103. The precursor from step 103 is calcined to form a preliminary product in step 105, such as being reduced or oxidized by exposure to heat. Then, a lithium-based additive is provided in step 107, such as lithium oxide (Li₂O). In step 109, the lithium-based additive and the preliminary product from step 105 are mixed, and produces the over-stoichiometric lithium cation-disordered rock salt cathode in step 111. The over-stoichiometric lithium cation-disordered rock salt cathode of step 111 follows Formula 1 provided above.

As an example, an embodiment over-stoichiometric lithium cation-disordered rock salt cathode is produced using the first exemplary method 100 by providing stoichiometric amounts of lithium-based compounds of Li₂CO₃, and LiF, and transition metal-based compounds TiO₂, and Mn₂O₃, as discussed in step 101. Under step 103, the compounds are mixed to form a homogeneous precursor. Then, the precursor is calcined in step 105 at a high temperature to form the preliminary product. An example preliminary product is Li_{1.2}Ti_{0.2}Mn_{0.6}O_{1.8}F_{0.2}. Finally, in step 107 the preliminary product is mixed with a lithium-based additive of Li₂O to produce an over-stoichiometric lithium cation-disordered rock salt cathode in step 111. Examples of over-stoichiometric lithium cation-disordered rock salts include a metastabilized over-stoichiometric lithium-based and transition metal-based cation-disordered rock salt of Formula 1 having an extra 10% mole ratio of Li₂O (such as Li_{1.333}Ti_{0.190}Mn_{0.571}O_{1.810}F_{0.190}, wherein x=0.190, a=1.143, b=0.762, x/(a+b)=0.1), and an extra 20% mole ratio of Li₂O (such as Li_{1.455}Ti_{0.182}Mn_{0.545}O_{1.818}F_{0.182}, wherein x=0.364, a=1.091, b=0.727, x/(a+b)=0.2).

A second exemplary method 150 to synthesize an over-stoichiometric lithium-based cation-disordered rock salt cathode is shown in FIG. 1B. The second exemplary method 150 also provides at least one lithium-based and at least one transition metal-based compound in step 151, then mix the provided compounds with high energy milling in step 153, such as using a high-energy planetary ball mill with a milling rate higher than 300 revolutions per minute (rpm). The mixing in step 153 produces an over-stoichiometric lithium-based cation-disordered rock salt cathode in step 155. The over-stoichiometric lithium-based cation-disordered rock salt cathode of step 155 also follows Formula 1 provided above.

As an example, an exemplary embodiment over-stoichiometric lithium cation-disordered rock salt cathode was produced using the second exemplary method 150 by using a designated amounts of the lithium-based compounds Li₂O, and LiF, and transition metal-based compounds TiO₂, and Mn₂O₃ as discussed in step 151. The compounds are mixed with high energy in step 153 to produce an over-stoichiometric lithium cation-disordered rock salt cathode in step 155.

In some embodiments, over-stoichiometric lithium cation-disordered rock salt cathodes produced by method 100 and method 150 are selected from a group comprising of Li_{1.333}Ti_{0.190}Mn_{0.571}O_{1.810}F_{0.190} (MS10-LTMOF), Li_{1.455}Ti_{0.182}Mn_{0.545}O_{1.818}F_{0.182} (MS20-LTMOF), Li_{1.760}Ti_{0.160}Mn_{0.480}O_{1.840}F_{0.160} (MS50-LTMOF), Li_{1.333}Ti_{0.381}Mn_{0.381}O_{2.000} (MS10-LTMO), Li_{1.333}Nb_{0.190}Mn_{0.571}O_{2.000} (MS10-LNMO), and Li_{1.333}Fe_{0.952}O_{2.000} (MS10-LFO). The exemplary cathodes produced include over-stoichiometric lithium having extra mole ratio of lithium in an amount of between about greater than 0% and about 100% lithium, or between about 10% and about 100% lithium, or between about 10% and about 50%, or between about 10% and about 20%.

Over-stoichiometric lithium-based transition metal-based cation-disordered rock salt cathodes can be directly applied into a lithium-ion battery to be utilized alongside any desired anodes. In an embodiment, the produced over-stoichiometric lithium-based transition metal-based cation-disordered rock salt cathode is mixed with conducting additives (for example, acetylene black), and binding additives (for example, polyvinylidene fluoride).

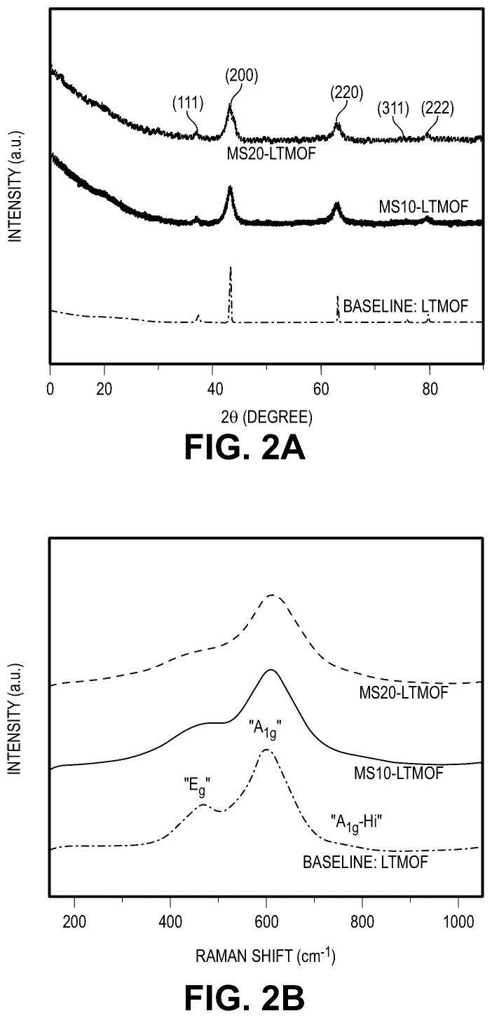

Exemplary embodiments of over-stoichiometric lithium cation-disordered rock salt cathodes produced under method 100 and method 150 show improved electrochemical properties that are further demonstrated under the following examples with measured data provided in the graphs shown in FIGS. 2A to 14E.

In an example, a stoichiometrically balanced lithium-based manganese-based cation-disordered rock salt having the chemical formula of Li_{1.2}Ti_{0.2}Mn_{0.6}O_{1.8}F_{0.2} (hereinafter as “LTMOF”) was synthesized as a comparative example, and two over-stoichiometric lithium-based manganese-based cation-disordered rock salts having the chemical formula of Li_{1.333}Ti_{0.190}Mn_{0.571}O_{1.810}F_{0.190}, which includes 10% extra mole ratio of lithium (hereinafter as “MS10-LTMOF”), and Li_{1.455}Ti_{0.182}Mn_{0.545}O_{1.818}F_{0.182}, which includes 20% extra mole ratio of lithium (hereinafter as “MS20-LTMOF”) have been synthesized using the following method.

The comparative stoichiometrically balanced lithium-based cation-disordered rock salt of LTMOF was synthesized by mixing a stoichiometric amounts of Li₂CO₃, TiO₂, Mn₂O₃, and LiF with ethanol at 200 rpm for 18 hours in a planetary ball mill. 10% extra Li₂CO₃ was added to compensate the Li loss in the high-temperature calcination process. After drying at 80° C. for 24 hours, and grinding the dried composite, then calcinating the powders at 950° C. for 12 hours in a furnace to obtain the stoichiometrically balanced LTMOF.

Exemplary over-stoichiometric lithium-based cation-disordered rock salt cathodes of MS10-LTMOF and MS20-LTMOF were synthesized through the room-temperature mechano-synthesis method described in the first exemplary method 100. After adding an extra amount of Li₂O (such as an extra 10% mole ratio of Li₂O to obtain MS10-LTMOF, or an extra 20% mole ratio of Li₂O to obtain MS20-LTMOF) to the originally stoichiometrically balanced LTMOF, the compounds were dry-mixed and then milled in a zirconia jar with 5 mm zirconia balls at 450 rpm for 24 hours in a planetary ball mill to produce over-stoichiometric lithium-based manganese-based cation-disordered rock salts.

Tests of the exemplary over-stoichiometric lithium-based manganese-based cation-disordered rock salt cathodes MS10-LTMOF and MS20-LTMOF, with the comparative stoichiometric lithium-based cation-disordered rock salt cathode LTMOF, indicate that a minor amount of over-stoichiometric lithium incorporation greatly stimulates redox activity. The extra redox activity of the over-stoichiometric metastable cation-disordered rock salts is backed by systematic X-ray diffraction (XRD), resonant Raman spectroscopy, and the results of tested electrochemical performances of each of the synthesized over-stoichiometric cathodes as compared to the stoichiometric cathode.

FIG. 2A shows the X-ray diffraction patterns of the over-stoichiometric MS10-LTMOF cation-disordered rock salt cathode and the over-stoichiometric MS20-LTMOF cation-disordered rock salt cathode as compared to the baseline of the stoichiometric LTMOF cation-disordered rock salt cathode. Both MS10-LTMOF and MS20-LTMOF cation-disordered rock salt demonstrate typical rock salt-like XRD pattern. The broader peaks of MS10-LTMOF and MS20-LTMOF are due to their smaller particle size compared to the baseline LTMOF.

FIG. 2B shows the Raman spectra of the over-stoichiometric MS10-LTMOF cation-disordered rock salt cathode and the over-stoichiometric MS20-LTMOF cation-disordered rock salt cathode as compared to the stoichiometric LTMOF cation-disordered rock salt cathode. The Raman bands of MS10-LTMOF and MS20-LTMOF demonstrate significant broadening and shift due to incorporation of over-stoichiometric Li.

Both FIGS. 2A and 2B similarly show that the intensity increases from the baseline stoichiometric LTMOF cathode as more over-stoichiometric Li is incorporated. As shown, the MS20-LTMOF cathode has more intensity than the MS10-LTMOF cathode on both the X-ray diffraction pattern graph and the Raman spectra graph.

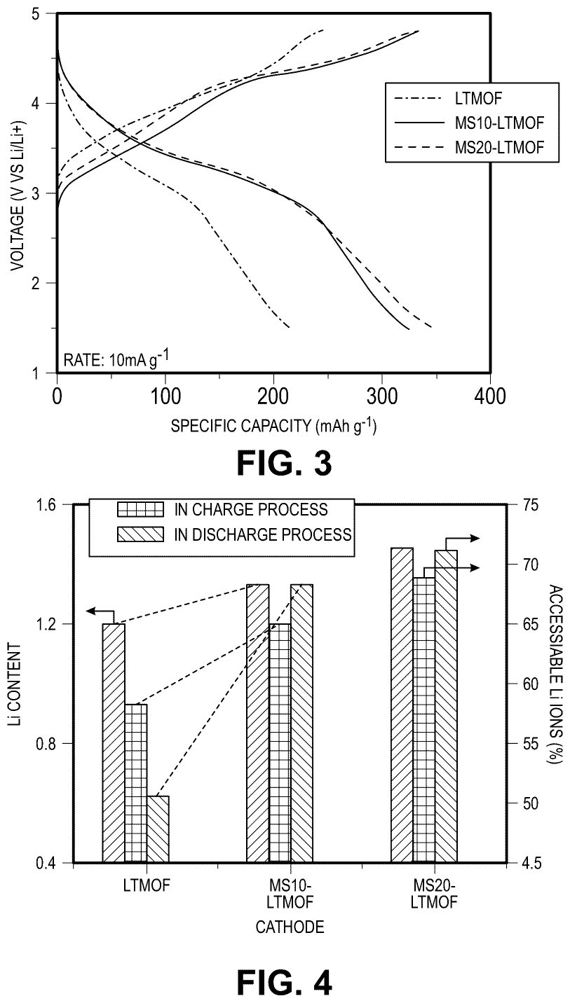

FIG. 3 shows a graph of the comparative electrochemical performance of the stoichiometric LTMOF compared to the over-stoichiometric MS10-LTMOF and the MS20-LTMOF in the first cycle at a rate of 10 mA g⁻¹. The graph shows significant improvement of specific capacity of over-stoichiometric MS10-LTMOF and MS20-LTMOF compared to stoichiometric LTMOF.

FIG. 4 shows a graph that measures the amount of accessible ions between the stoichiometric LTMOF cathode compared to the over-stoichiometric MS10-LTMOF and the MS20-LTMOF cathodes. The graph shows that over-stoichiometric MS10-LTMOF and the MS20-LTMOF cathodes both have an improved amount of accessible lithium ions overall, as compared to the stoichiometric LTMOF cathode. This improved amount of accessible lithium ions shows that the over-stoichiometric lithium-based cation-disordered rock salts have a higher electrochemical capacity than the stoichiometric LTMOF compound.

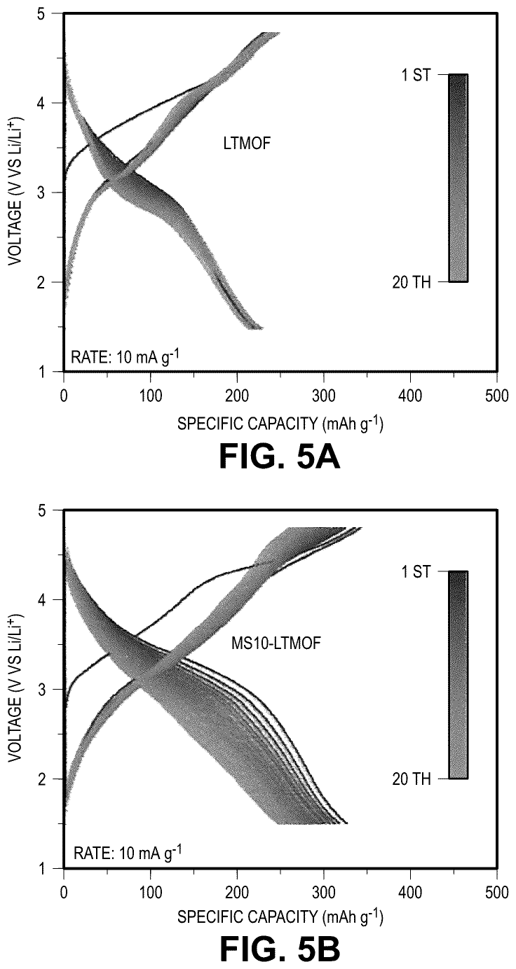

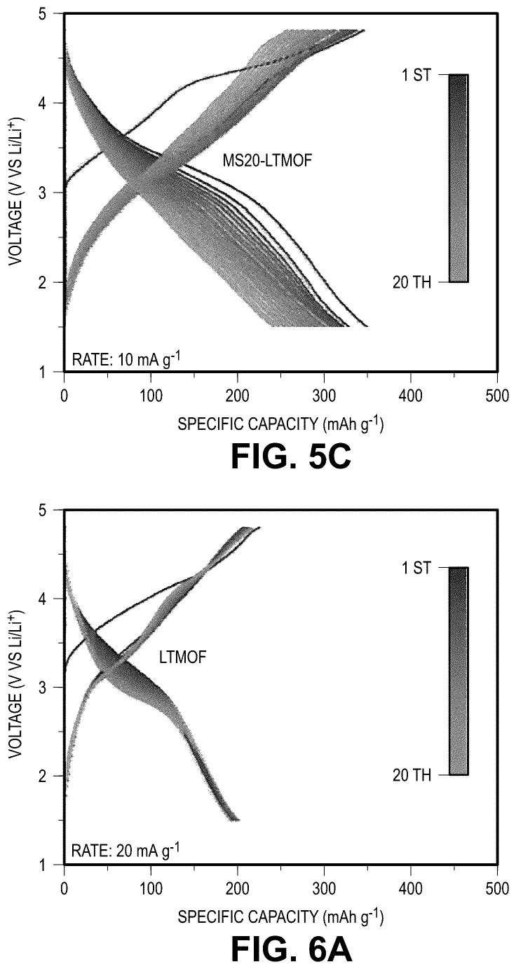

FIGS. 5A, 5B, and 5C show the measured electrochemical performances of the stoichiometric LTMOF cathode (FIG. 5A) compared to the over-stoichiometric MS10-LTMOF cathode (FIG. 5B) and the MS20-LTMOF cathode (FIG. 5C) in the first 20 cycles under the current density of 10 mA g⁻¹. The charts show that the MS10-LTMOF and MS20-LTMOF cathodes both had increases in specific capacity as compared to the stoichiometric LTMOF cathode.

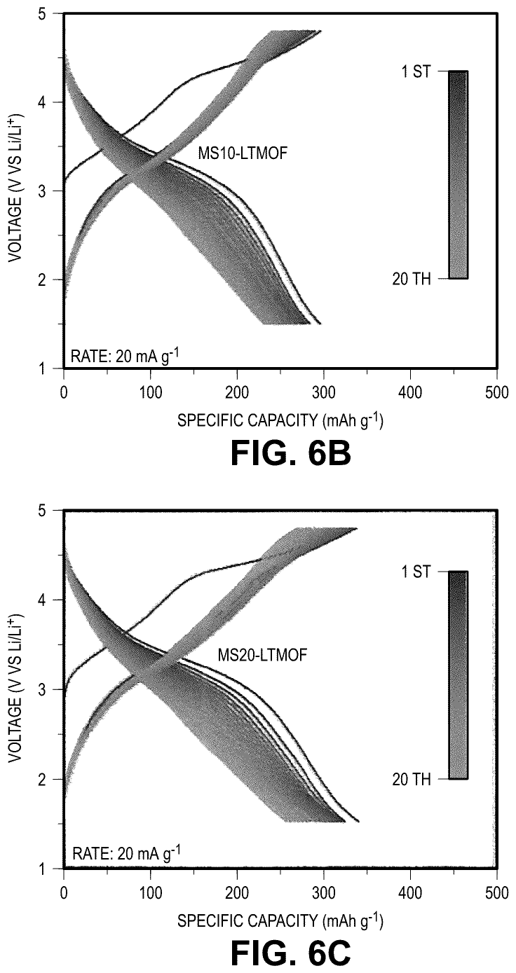

Similarly, FIGS. 6A, 6B, and 6C show the measured electrochemical performances of the stoichiometric LTMOF cathode (FIG. 6A) compared to the over-stoichiometric MS10-LTMOF cathode (FIG. 6B) and the MS20-LTMOF cathode (FIG. 6C) in the first 20 cycles under the current density of 20 mA g⁻¹. The charts also show that the MS10-LTMOF and MS20-LTMOF cathodes both had increases in specific capacity as compared to the stoichiometric LTMOF cathode.

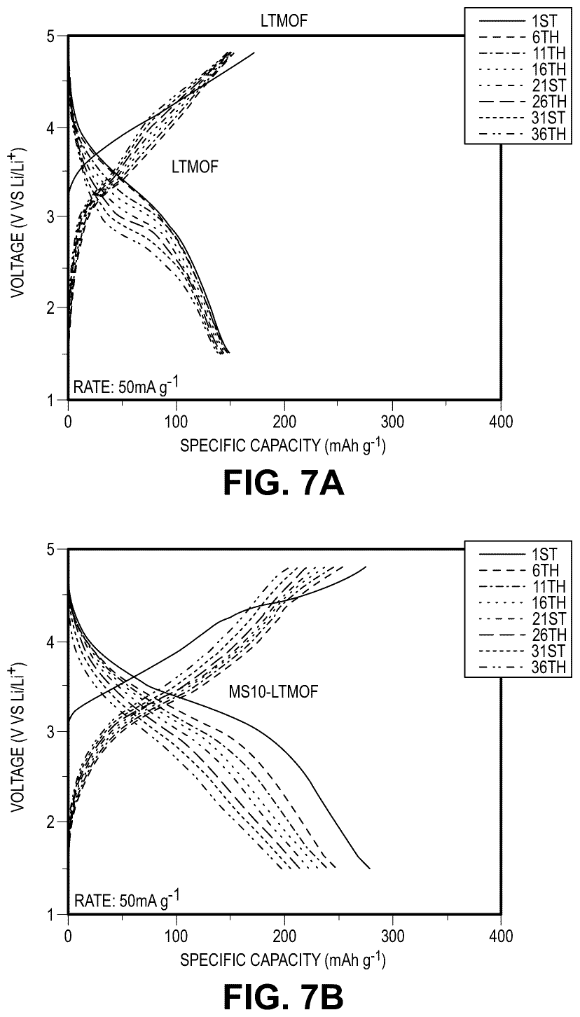

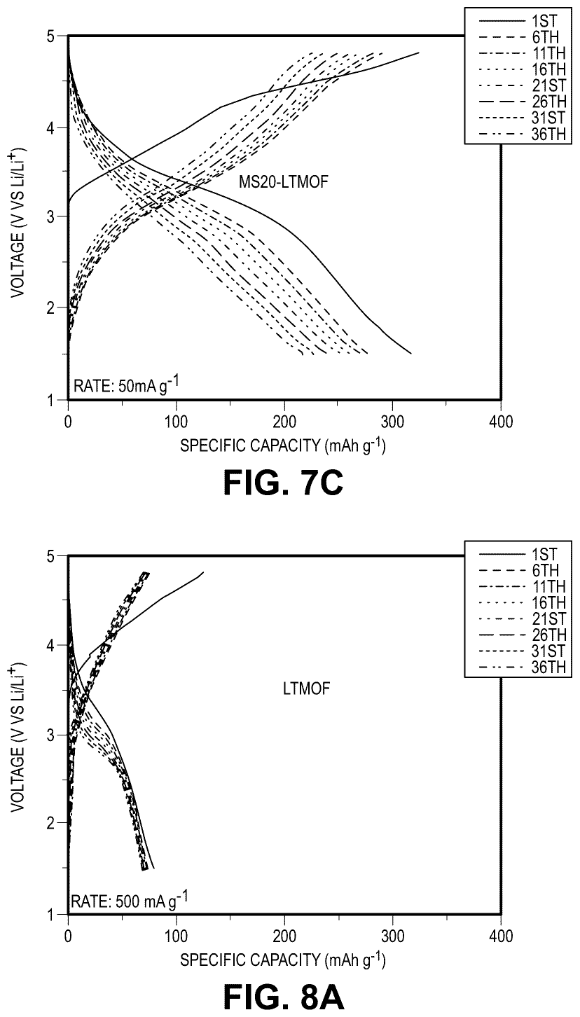

Correspondingly, FIGS. 7A, 7B, and 7C show the measured electrochemical performances of the stoichiometric LTMOF cathode (FIG. 7A) compared to the over-stoichiometric MS10-LTMOF cathode (FIG. 7B) and the MS20-LTMOF cathode (FIG. 7C) of every five cycles in the first 40 cycles under the current density of 50 mA g⁻¹. The charts also show that the MS10-LTMOF and MS20-LTMOF cathodes both had increases in specific capacity as compared to the stoichiometric LTMOF cathode.

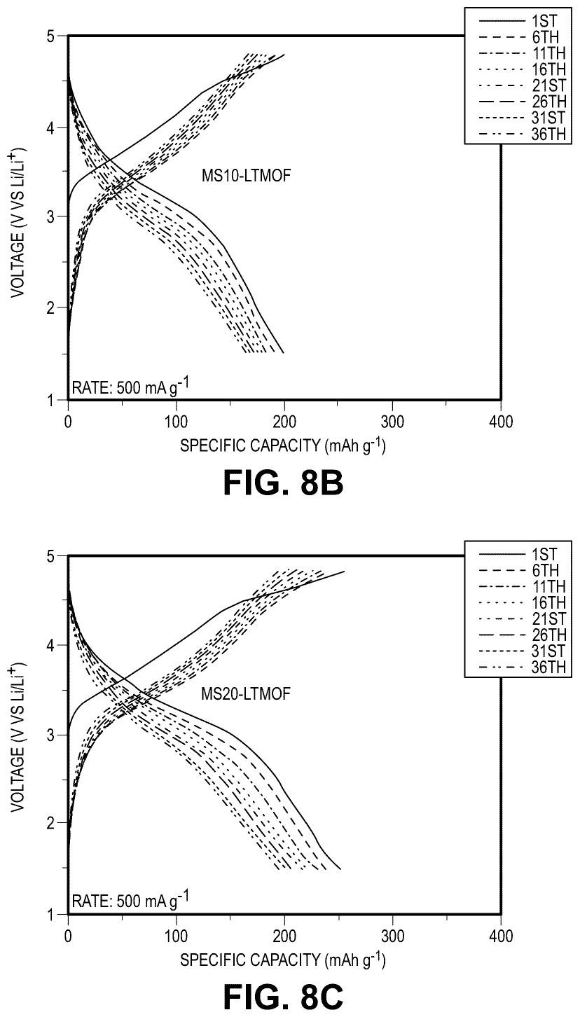

Also similarly, FIGS. 8A, 8B, and 8C show the measured electrochemical performances of the stoichiometric LTMOF cathode (FIG. 8A) compared to the over-stoichiometric MS10-LTMOF cathode (FIG. 8B) and the MS20-LTMOF cathode (FIG. 8C) of every five cycles in the first 40 cycles under the current density of 500 mA g⁻¹. The charts show even more clearly than the previous current densities that the MS10-LTMOF and MS20-LTMOF cathodes both had more specific capacity as compared to the stoichiometric LTMOF cathode.

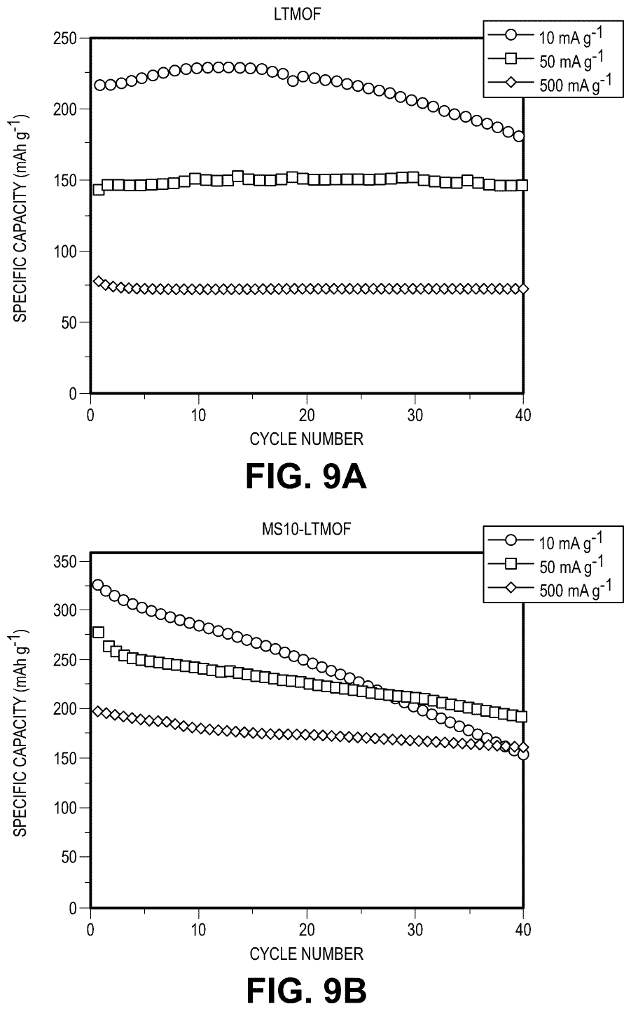

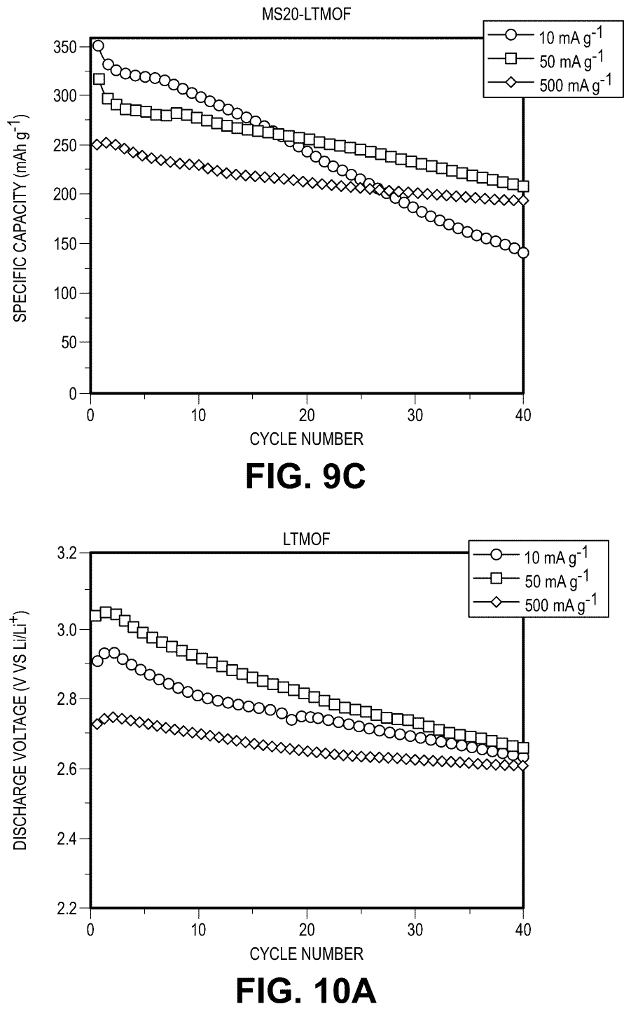

FIGS. 9A, 9B, and 9C show the measured discharge specific capacity retention of the stoichiometric LTMOF cathode (FIG. 9A) compared to the over-stoichiometric MS10-LTMOF cathode (FIG. 9B) and the MS20-LTMOF cathode (FIG. 9C) under the current density of 10, 50, and 500 mA g⁻¹. The graphs show that the specific capacity of MS10-LTMOF cathode and MS20-LTMOF cathode under each of the different current densities are significantly higher than the stoichiometric LTMOF cathode.

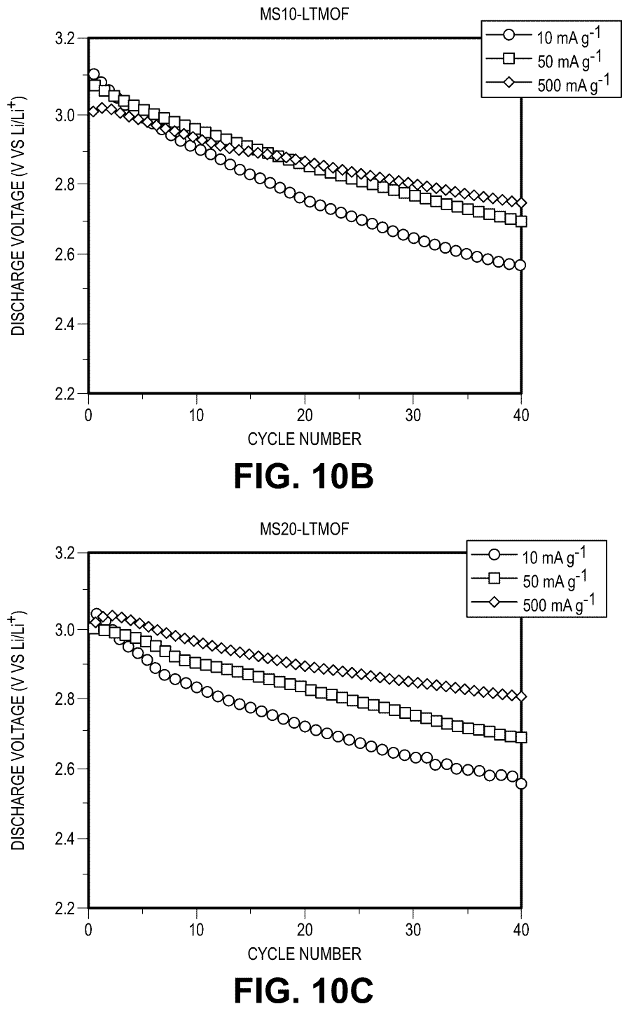

FIGS. 10A, 10B, and 10C show the discharge voltage retention of the stoichiometric LTMOF cathode (FIG. 10A) compared to the over-stoichiometric MS10-LTMOF cathode (FIG. 10B) and the MS20-LTMOF cathode (FIG. 10C) under current densities of 10 mA g⁻¹, 50 mA g⁻¹, and 500 mA g⁻¹. It can be seen that, under each of the different current densities, the over-stoichiometric MS10-LTMOF and MS20-LTMOF cathodes discharge higher voltage overall than the stoichiometric LTMOF cathode.

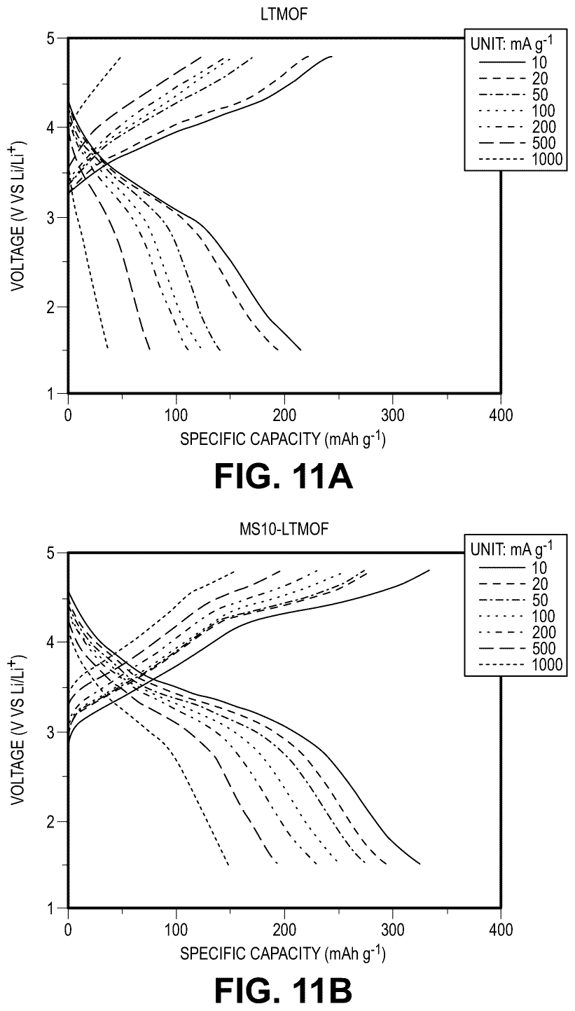

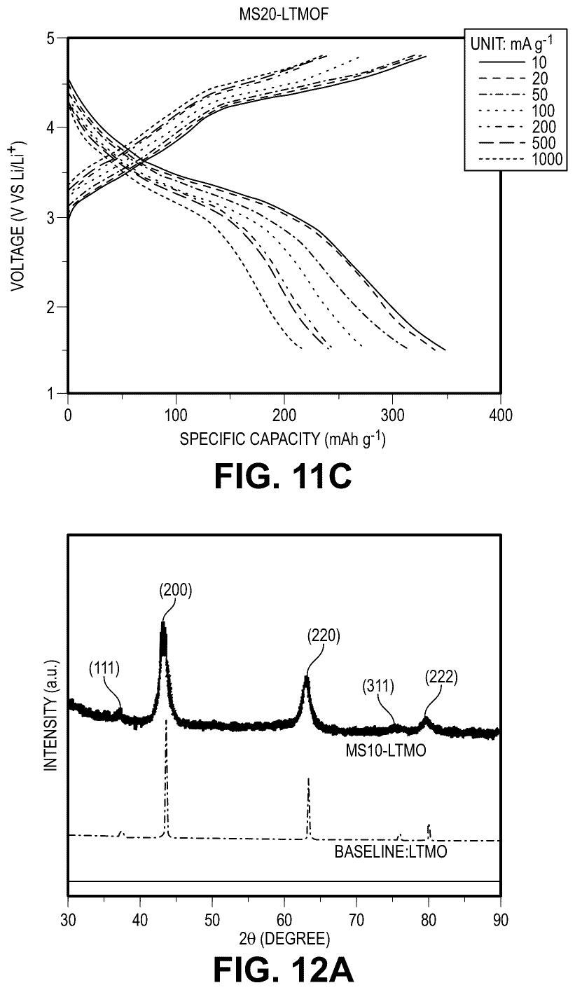

FIGS. 11A, 11B, and 11C show the rate performance of the stoichiometric LTMOF cathode (FIG. 11A) compared to the over-stoichiometric MS10-LTMOF cathode (FIG. 11B) and the MS20-LTMOF cathode (FIG. 11C) under different current densities. The graphs show that the over-stoichiometric MS10-LTMOF and MS20-LTMOF cathodes both include higher specific capacity than the stoichiometric LTMOF cathode from low current density to high current density.

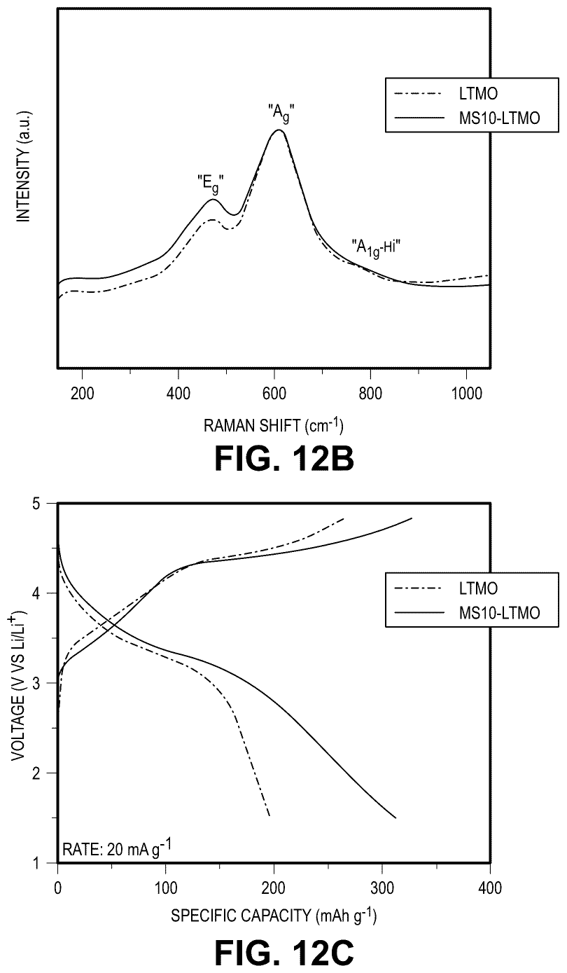

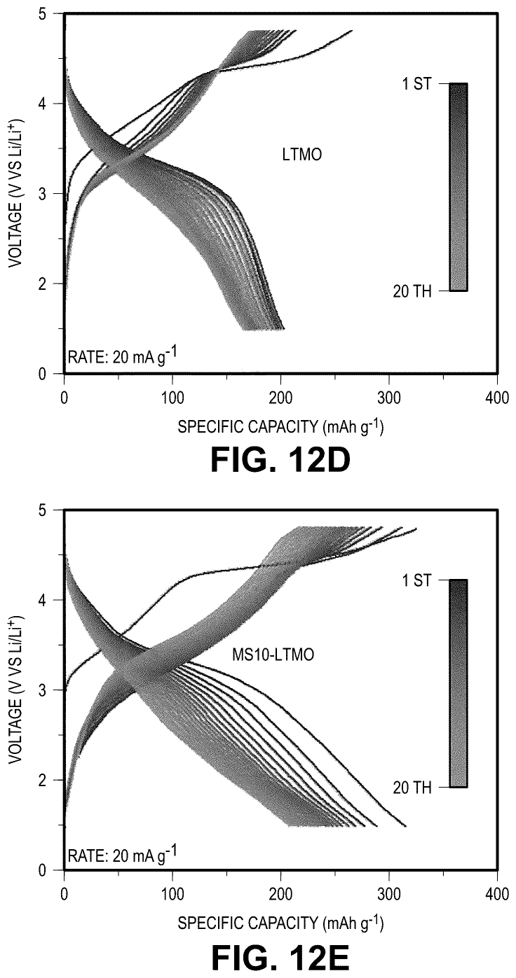

In another embodiment, FIGS. 12A to 12E, using a Li—Ti—Mn—O based rock salt, MS10-LTMO can also be similarly synthesized using either the first exemplary method 100 or the second exemplary method 150, and be similarly tested using a stoichiometric comparative example LTMO cathode and over-stoichiometric MS10-LTMO cathode. FIG. 12A shows the X-ray diffraction patterns of each sample. FIG. 12B shows the Raman spectra graph of each sample. FIG. 12C shows the electrochemical performance in the first cycle of each sample. FIG. 12D shows the electrochemical performance in the first 20 cycles for the stoichiometric LTMO cathode, and FIG. 12E shows the electrochemical performance in the first 20 cycles for the over-stoichiometric MS10-LTMO cathode. Similarly, MS10-LTMO cation-disordered rock salt demonstrates typical rock salt-like XRD pattern. The broader peaks of MS10-LTMO are due to their smaller particle size compared to the baseline LTMO. The Raman bands of MS10-LTMO demonstrate significant broadening and shift due to incorporation of over-stoichiometric Li. Specific capacity in FIG. 12C to 12E are tested under 20 mA g⁻¹. The graphs show that, overall, the over-stoichiometric MS10-LTMO cathode has a higher performance than the stoichiometric LTMO cathode.

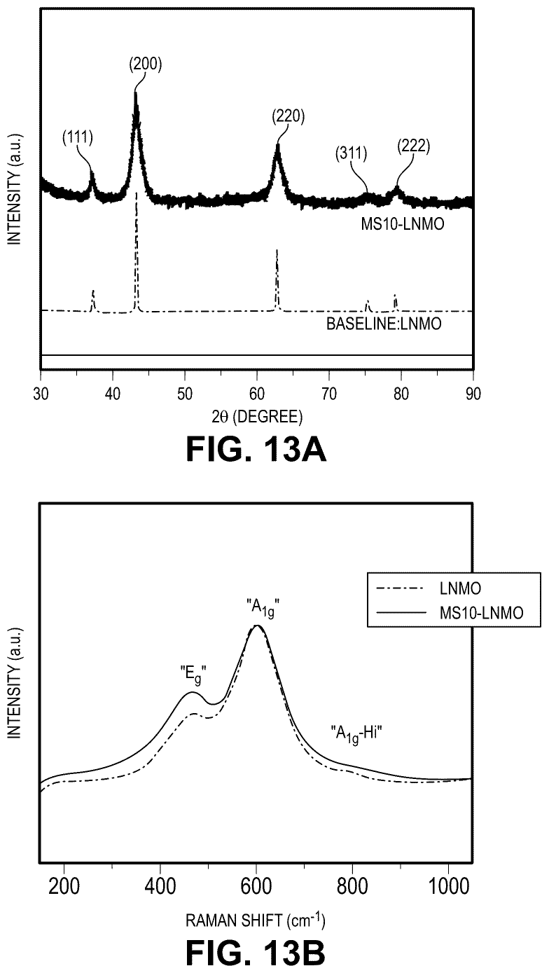

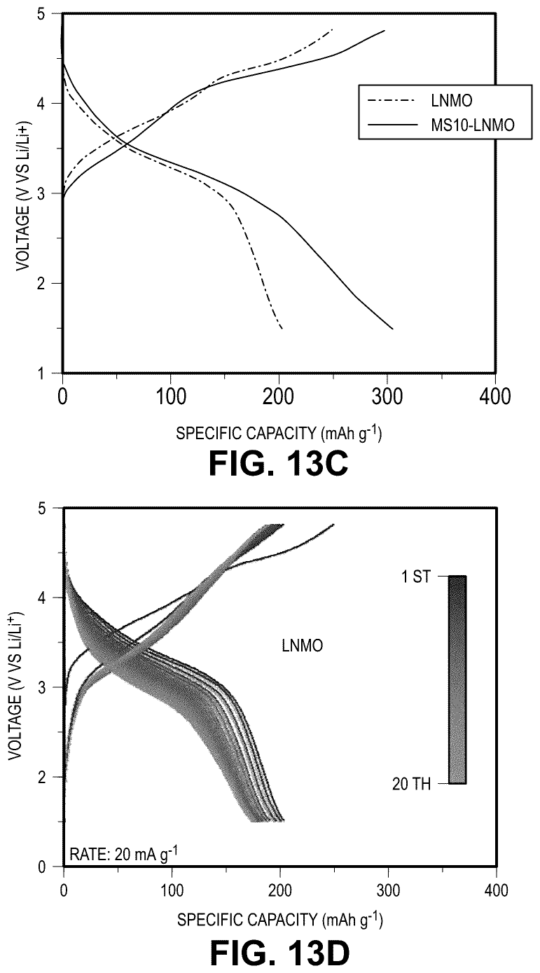

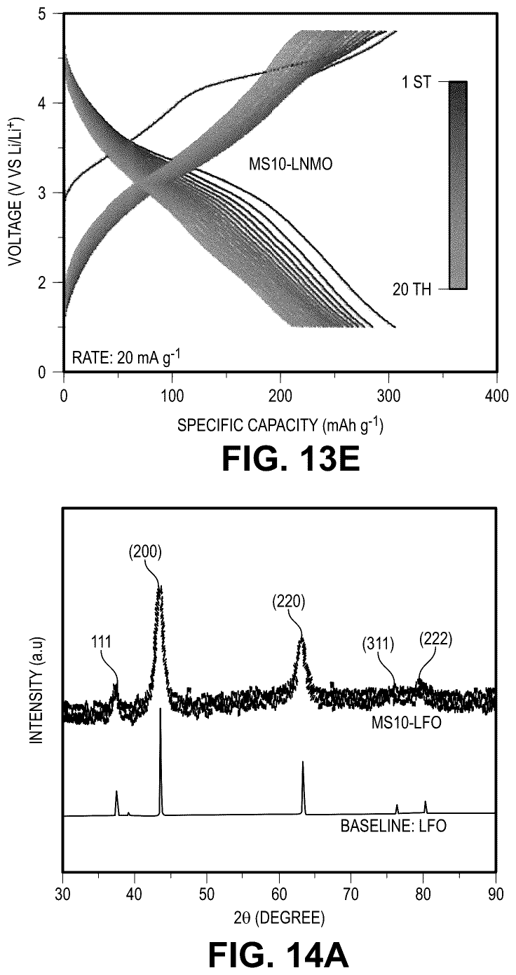

In a further embodiment, using a Li—Nb—Mn—O based rock salt, MS10-LNMO can be synthesized using either the first exemplary method 100 or the second exemplary method 150, and be similarly tested to compare a stoichiometric comparative example LNMO cathode to an over-stoichiometric MS10-LNMO cathode. FIG. 13A shows the X-ray diffraction patterns of each sample. FIG. 13B shows the Raman spectra graph of each sample. FIG. 13C shows the electrochemical performance in the first cycle of each sample. FIG. 13D shows the electrochemical performance in the first 20 cycles for the stoichiometric LNMO cathode, and FIG. 13E shows the electrochemical performance in the first 20 cycles for the over-stoichiometric MS10-LNMO cathode. Similarly, MS10-LNMO cation-disordered rock salt demonstrates typical rock salt-like XRD pattern. The broader peaks of MS10-LNMO are due to their smaller particle size compared to the baseline LNMO. The Raman bands of MS10-LNMO demonstrate significant broadening and shift due to incorporation of over-stoichiometric Li. Specific capacity in FIG. 13C to 13E are tested under 20 mA g⁻¹. The graphs show that, overall, the over-stoichiometric MS10-LNMO cathode has a higher performance than the stoichiometric LNMO cathode.

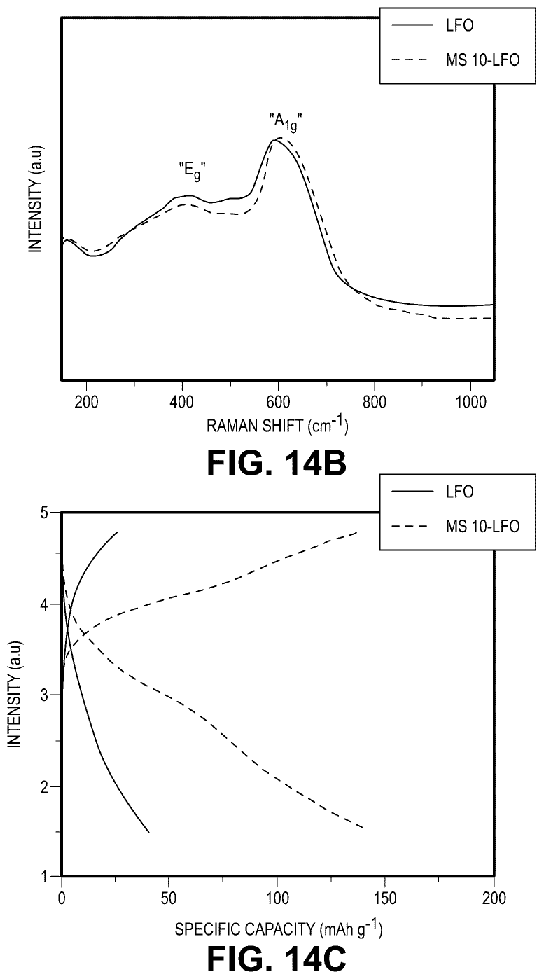

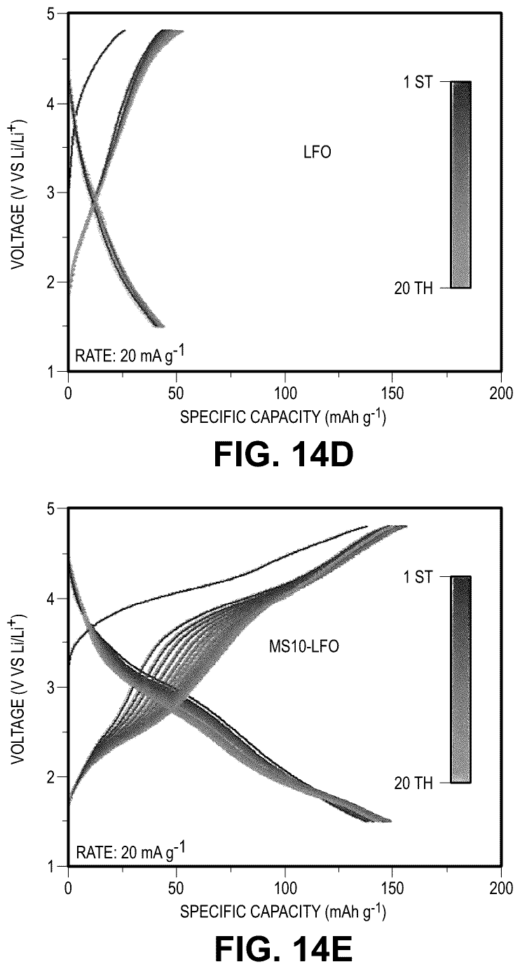

In yet another embodiment, similarly, using a Li—Fe—O based rock salt, MS10-LFO can be synthesized using either the first exemplary method 100 or the second exemplary method 150, and be similarly compared between a stoichiometric comparative example LFO cathode and an over-stoichiometric MS10-LFO cathode. FIG. 14A shows the X-ray diffraction patterns of each sample. FIG. 14B shows the Raman spectra graph of each sample. FIG. 14C shows the electrochemical performance in the first cycle of each sample. FIG. 14D shows the electrochemical performance in the first 20 cycles for the stoichiometric LFO cathode, and FIG. 14E shows the electrochemical performance in the first 20 cycles for the over-stoichiometric MS10-LFO cathode. Similarly, MS10-LFO cation-disordered rock salt demonstrates typical rock salt-like XRD pattern. The broader peaks of MS10-LFO are due to their smaller particle size compared to the baseline LFO. Specific capacity in FIG. 14C to 14E are tested under 20 mA g⁻¹. The graphs show that, overall, the over-stoichiometric MS10-LFO cathode has a significantly higher performance than the stoichiometric LFO cathode.

By introducing over-stoichiometric lithium to a transition metal-based cation-disordered rock salt, such as a moderately small of extra lithium between an amount of about 10% to about 50% mole ratio of lithium, via a low temperature mechanochemistry, it allows a relaxation of the site-balance constraint of the solid-state-synthesized cation-disordered rock salts. The over-stoichiometric metastabilization increases the degree of disordering in the rock salt, which enhances the amount of electrochemical utilizable lithium to be present in the compound and unlocks more redox activity of cation-disordered rock salts.

The over-stoichiometric lithium method to metastabilize cation-disordered rock salts is seen to be applicable to different lithium-based transition metal-based cation-disordered rock salts, as shown by the graphs of the measured data of each of the metastabilized samples, such as the MS10-LTMOF, MS20-LTMOF, MS10-LTMO, MS10-LNMO, and MS10-LFO. The lithium deintercalation in over-stoichiometric samples generally involves more significant lattice dimension change, more redox activity from oxygen, and changes of the short-range ordering scheme at the fully charged state. The performance of the over-stoichiometric lithium-based transition metal-based cation-disordered rock salt cathodes are shown to be systematically higher than the respective stoichiometrically balanced cation-disordered rock salts. The testing data of metastable over-stoichiometric lithium-based transition metal-based cation-disordered rock salt cathodes are shown to have promising improvements to lithium-ion batteries.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An over-stoichiometric cation-disordered rock salt cathode comprising:
a cation-disordered rock salt having an over-stoichiometric amount of lithium, and at least one transition metal.

2. The over-stoichiometric cation-disordered rock salt of claim 1, wherein cation-disordered rock salt has a chemical formula of
Liₐ₊ₓM_{b}O_{2-y}F_{y},
wherein a≥1,
wherein b≥0.4,
wherein 0≤x≤1.0*(a+b),
wherein y≥0, and
wherein M comprises a transition metal selected from one of titanium, vanadium, chromium, manganese, iron, cobalt, nickel, zirconium, niobium, molybdenum, ruthenium, tantalum, and tungsten, or a combination thereof.

3. The over-stoichiometric cation-disordered rock salt of claim 2, wherein the sum of a+x and b is equal to greater than 2.

4. The over-stoichiometric cation-disordered rock salt of claim 1, wherein the over-stoichiometry amount of lithium is an extra mole ratio of lithium of between about 10% and about 100%.

5. The over-stoichiometric cation-disordered rock salt of claim 1, wherein the cation-disordered rock salt is selected from a group comprising of Li_{1.333}Ti_{0.190}Mn_{0.571}O_{1.810}F_{0.190}, Li_{1.455}Ti_{0.182}Mn_{0.545}O_{1.818}F_{0.182}, Li_{1.760}Ti_{0.160}Mn_{0.480}O_{1.840}F_{0.160}, Li_{1.333}Ti_{0.381}Mn_{0.381}O_{2.000}, Li_{1.333}Nb_{0.190}Mn_{0.571}O_{2.000}, and Li_{1.333}Fe_{0.952}O_{2.000}.

6. The over-stoichiometric cation-disordered rock salt of claim 1, wherein the cation-disordered rock salt is in a metastable state.

7. A lithium-ion battery having an over-stoichiometric lithium, comprising:
a cathode having a cation-disordered rock salt that includes an over-stoichiometric amount of lithium and at least one transition metal; and
an anode.

8. The lithium-ion-battery of claim 7, wherein the cation-disordered rock salt has a chemical formula of
Liₐ₊ₓM_{b}O_{2-y}F_{y},
wherein a≥1,
wherein b≥0.4,
wherein 0≤x≤1.0*(a+b),
wherein y≥0, and
wherein M comprises a transition metal selected from one of titanium, vanadium, chromium, manganese, iron, cobalt, nickel, zirconium, niobium, molybdenum, ruthenium, tantalum, and tungsten, or a combination thereof.

9. The lithium-ion battery of claim 8, wherein the sum of a+x and b is equal to greater than 2.

10. The lithium-ion battery of claim 7, wherein the over-stoichiometric amount of lithium is an extra mole ratio of lithium of between about 10% and about 100%.

11. The lithium-ion battery of claim 7, wherein the cation-disordered rock salt is selected from a group comprising of Li_{1.333}Ti_{0.190}Mn_{0.571}O_{1.810}F_{0.190}, Li_{1.455}Ti_{0.182}Mn_{0.545}O_{1.818}F_{0.182}, Li_{1.760}Ti_{0.160}Mn_{0.480}O_{1.840}F_{0.160}, Li_{1.333}Ti_{0.381}Mn_{0.381}O_{2.000}, Li_{1.333}Nb_{0.190}Mn_{0.571}O_{2.000}, and Li_{1.333}Fe_{0.952}O_{2.000}.

12. The lithium-ion battery of claim 7, wherein the cation-disordered rock salt is in a metastable state.

13. A method of synthesizing an over-stoichiometric cation-disordered rock salt cathode for a lithium-ion battery comprising:
providing at least one lithium-based transition metal-based compound;
mixing the lithium-based transition metal-based compound with a lithium-based additive; and
producing an over-stoichiometric lithium-based transition metal-based cation-disordered rock salt cathode.

14. The method of claim 13, wherein the mixing is performed with a mechanochemical method.

15. The method of claim 13, wherein the mixing is performed with high energy.

16. The method of claim 13, wherein the over-stoichiometric lithium-based transition metal-based cation-disordered rock salt cathode has a chemical formula of
Liₐ₊ₓM_{b}O_{2-y}F_{y},
wherein a≥1,
wherein b≥0.4,
wherein 0≤x≤1.0*(a+b),
wherein y≥0, and
wherein M comprises a transition metal selected from one of titanium, vanadium, chromium, manganese, iron, cobalt, nickel, zirconium, niobium, molybdenum, ruthenium, tantalum, and tungsten, or a combination thereof.

17. The method of claim 16, wherein the sum of a+x and b is equal to greater than 2.

18. The method of claim 13, wherein the over-stoichiometric amount of lithium includes an extra mole ratio of lithium of between about 10% and about 100%.

19. The method of claim 13, wherein the over-stoichiometric lithium-based transition metal-based cation-disordered rock salt cathode has a mole ratio of total cations to total anions being greater than 1:1.

20. The method of claim 13, further comprising incorporating the over-stoichiometric lithium-based transition metal-based cation-disordered rock salt cathode into a lithium-ion battery.
